(19) United States
(12) Patent Application Publication
(10) Pub. No.: US 2012/0013833 A1
(43) Pub. Date: Jan. 19, 2012

(54) LIQUID CRYSTAL DISPLAY PANEL

(75) Inventors: Ting-Yu Chang, Kaohsiung County (TW); Hsien-Wei Chiang, Taipei City (TW); Ching-Fu Hsu, Taichung County (TW)

(73) Assignees: WINTEK CORPORATION, Taichung City (TW); WINTEK TECHNOLOGY(H.K) LTD., Dongguan City (CN)

(21) Appl. No.: 13/183,456

(22) Filed: Jul. 15, 2011

(30) Foreign Application Priority Data
Jul. 16, 2010 (TW) 99123491

(51) Int. Cl. G02F 1/1333

(52) U.S. Cl. 349/122

(57) ABSTRACT

A liquid crystal display panel including a first substrate, a second substrate, an active device array, a solar cell structure, an isolating layer, a cholesteric liquid crystal layer, and a common electrode layer is provided. The second substrate faces opposite to the first substrate. The active device array is disposed on the first substrate and between the first substrate and the second substrate. The solar cell structure is disposed on the second substrate and between the second substrate and the active device array. The isolating layer is disposed between the solar cell structure and the active device array. The cholesteric liquid crystal layer is disposed between the isolating layer and the active device array. The common electrode layer is disposed between the cholesteric liquid crystal layer and the isolating layer. Two opposite sides of the isolating layer directly contact with the common electrode layer and the solar cell structure, respectively.

### CROSS-REFERENCE TO RELATED APPLICATION

This application claims the priority benefit of Taiwan application serial no. 99123491, filed on Jul. 16, 2010. The entirety of the above-mentioned patent application is hereby incorporated by reference herein and made a part of this specification.

### BACKGROUND

1. Field of the Invention

The present invention relates to a liquid crystal display panel, and more particularly to a liquid crystal display panel applying cholesteric liquid crystal materials as the display medium.

2. Description of Related Art

In recent years, flexible display panels, electronic papers, and electronic books are being rapidly developed. The display media employed in these devices include liquid crystal displays, electrophoretic displays, electrochromic displays and electrolytic displays. In the application of electronic papers, compared with the displays constructed with other display materials, a display formed with a cholesteric liquid crystal material is brighter and has better contrast. In addition, a cholesteric LCD has a bi-stable characteristic, and only requires an appropriate driving voltage when frames are being updated; thus, a cholesteric LCD is more power efficient. Accordingly, cholesteric liquid crystals are quite appropriate for e-papers and e-books.

As the awareness towards environmental protection increases around the globe, solar cells that are capable of photoelectric conversion becomes important and are being used in portable electronic devices (such as, e-papers and e-books). The power demand of e-papers and e-books is not high. Hence, when the photoelectric conversion efficiency of a solar cell is sufficient, no additional power is required for the e-books and e-papers.

Generally speaking, a display panel of the e-papers and e-books and a solar cell are independent structures. To integrate a display panel and a solar cell together typically mandates the use of an adhesive layer for adhering one of the substrates of the display panel with one of the substrates of the solar cell. However, the side of the solar cell that is facing the display panel may receive lights, which would become limited due to the presence of multiple substrates and adhesive layers. In other words, without turning the display panel of the e-papers and e-books, the photoelectric conversion efficiency of the solar cell will be undesirable.

### SUMMARY OF THE INVENTION

The present invention is directed to a liquid crystal display panel, wherein the solar cell structure provides the power required by the display.

The present invention provides a liquid crystal display panel that includes a first substrate, a second substrate, an active device array, a solar cell structure, an isolation layer, a cholesteric liquid crystal layer, and a common electrode layer. The second substrate faces opposite to the first substrate. The active device array is disposed on the first substrate, between the first substrate and the second substrate. The solar cell structure is disposed on the second substrate and is between the active device array and the second substrate. The isolation layer is disposed between the solar cell structure and the active device array. The cholesteric liquid crystal layer is disposed between the isolation layer and the active device array. The common electrode layer is disposed between the cholesteric liquid crystal layer and the isolation layer, and the two corresponding sides of the isolation layer are in direct contacting with the common electrode layer and the solar cell structure, respectively.

According to the exemplary embodiment of the disclosure, the solar cell structure is integrated in the liquid crystal display panel, and the ambient light may be transformed into the power required by the liquid crystal panel. Hence, the benefit of power-saving can be realized. Further, the solar cell structure and the common electrode of the liquid crystal display panel are directly disposed at the two corresponding sides of the isolation layer. Hence, the liquid crystal display panel is precluded from having a structure of multiple tightly adhered substrates. Instead, the solar cell structure may efficiently receive the ambient light to achieve the desirable photoelectric conversion efficiency.

In order to the make the aforementioned and other objects, features and advantages of the present invention comprehensible, a preferred embodiment accompanied with figures are described in detail below.

### BRIEF DESCRIPTION OF THE DRAWINGS

FIG. 1 and FIG. 2 are schematic cross-sectional views illustrating a liquid crystal display panel according to two exemplary embodiments of the invention.

### DESCRIPTION OF EMBODIMENTS

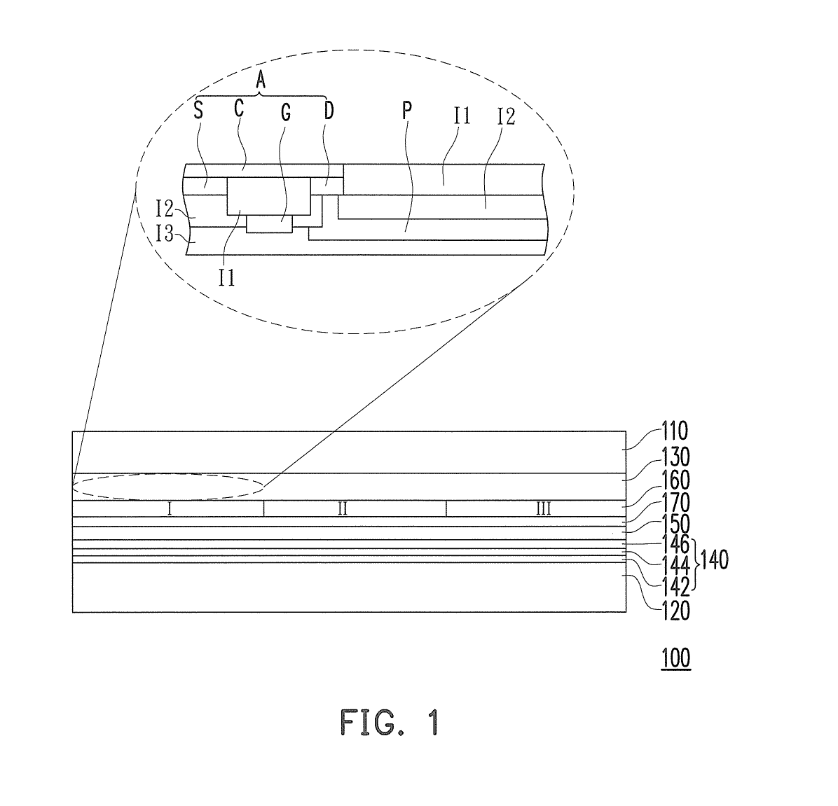

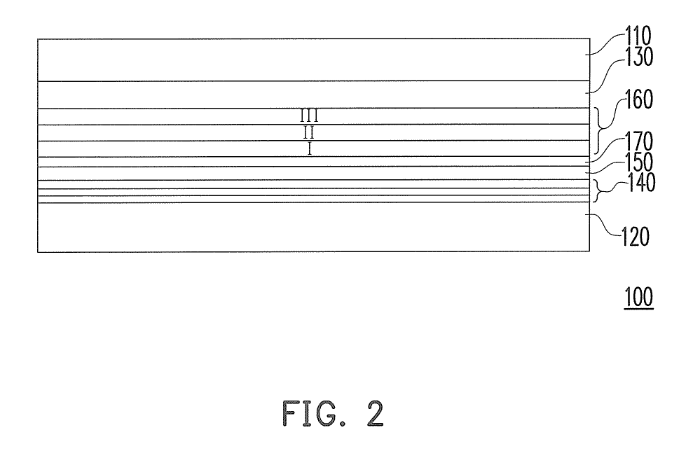

In the following description, reference is made to various exemplary embodiments in which the invention of a display panel integrated with a solar cell structure for raising the photoelectric conversion efficiency of the solar cell may be practiced. FIGS. 1 and 2 are schematic cross-sectional views illustrating a liquid crystal display panel according to two exemplary embodiments of the invention. Referring to FIG. 1, a liquid crystal display panel 100 includes a first substrate 110, a second substrate 120, an active device array 130, a solar cell structure 140, an isolation layer 150, a cholesteric liquid crystal layer 160, and a common electrode 170. The second substrate 120 and the first substrate 110 are configured opposite to each other. The active device array 130, the cholesteric liquid crystal layer 160, the common electrode layer 170, the isolation layer 150, and the solar cell structure 140 are sequentially arranged in a direction from the first substrate 110 toward the second substrate 120. In one exemplary embodiment, the active device array 130 is disposed on the first substrate 110, while the solar cell structure 140 is disposed on the second substrate 120.

The solar cell structure 140 may include a first conductive layer 142, a photovoltaic layer 144, and a second conductive layer 146. The first conductive layer 142 is disposed on the second substrate 120. The second conductive layer 146 is in direct contacting with the isolation layer 150. The photovoltaic layer 144 is disposed between the first conductive layer 142 and the second conductive layer 140. It should be understood by a person of ordinary skill practicing this invention that the solar cell structure 140 may include other film layers. The film layers being referred herein in the illustrated embodiments are presented by way of example and not by way of limitation.

In the exemplary embodiment, the active device array 130, the cholesteric liquid crystal layer 160, and the common electrode layer 170 are sequentially stacked as a display device. Moreover, the isolation layer 150 may be an integrated isolation structure, for example, a third substrate, an insulative passivation layer or an insulative anti-reflection layer. In essence, the isolation layer 150 is an insulative element of a continuous single layer (sheet shape or board shape) structure. The two corresponding sides of the isolation layer 150 are respectively in direct contacting with the common electrode layer 170 and the solar cell structure 140. Alternatively speaking, the common electrode layer 170 and the solar cell structure 140 are directly constructed on two corresponding sides of the isolation layer 150 for integrating the solar cell structure in the liquid crystal display panel 100.

For example, during the fabrication of the liquid crystal display panel 100, a solar cell package, which may include the third substrate (which is the isolation layer 150), the solar cell structure 140, and the second substrate 120, is first provided. The solar cell structure 140 is disposed between the third substrate (which is the isolation layer 150) and the second substrate 120. Thereafter, the common electrode layer 170 is constructed directly at one side of the third substrate (which is the isolation layer 150) that is away from the solar cell structure 140. The first substrate 110 configured with the active device array 130 is assembled with the third substrate (which is the isolation layer 150), followed by injecting a cholesteric liquid crystal layer 160 to complete the fabrication of the liquid crystal display panel 100.

During the fabrication of the liquid crystal display panel 100, the solar cell structure 140 may be fabricated on the second substrate 120 first, followed by forming the insulative passivation layer or the insulative anti-reflection layer (which is the isolation layer 150) on the solar cell structure 140. Thereafter, the common electrode layer 170 is formed directly at one side of the insualtive passivation layer or the insulative anti-reflection layer (which is the isolation layer 150) away from the solar cell structure 140. Then, the first substrate 110 disposed with the active device array 130 and the second substrate 120 are assembled together, the cholesteric liquid crystal layer 160 is injected therebetween to complete the liquid crystal display panel 100.

In other words, the solar cell structure 140 is constructed internally in the liquid crystal display panel 100 and is not packaged as an external attachment to the liquid crystal panel 100. Hence, the liquid crystal display panel 100 is precluded from employing a plurality of substrates adhered together using an adhesive layer. The assembling procedure is facilitated and the structure of the liquid crystal display panel 100 is simplified. Moreover, the irradiation of the solar cell structure 140 by lights being attenuated due to the disposition of the adhesive layer and the plurality of substrates is precluded. Therefore, the solar cell structure 140 integrated in the liquid crystal display panel 100 may maintain desirable photoelectric conversion efficiency. Hence, the design as disclosed in the exemplary embodiment enhances the photoelectric conversion efficiency of the solar cell structure 140, and the benefit power preservation is achieved.

It is worthy to note that the liquid crystal display panel 100 applies the lights reflected by the cholesteric liquid crystal material to present the to-be-displayed bright image. Further, the solar cell structure 140 may provide the light absorption function to present the dark image in absent of an externally provided light absorption layer. Alternatively speaking, in the design of the exemplary embodiment, the display side of the liquid crystal display panel 100 is the side at which the first substrate 110 is configured. Hence, it is not necessary to turn the liquid crystal display panel 100 (for example, having the display side facing down) for the solar cell structure 140 to achieve the desirable photoelectric conversion efficiency.

Additionally, the active device array 130 includes a first active device A and a pixel electrode P. The pixel electrode P electrically connects to the active device A, and the active device A includes a gate G, a source S, a drain D, and a channel layer C. Further, the active device array 130 may include and insulation layers Il, I2, I3 for isolating different conductive devices. The insulation layer I3 may provide the alignment function for adjusting the alignment direction of the cholesteric liquid crystal layer 160. The active device array 130 may also include a scan line, a data line, a common line, which are not shown in the Figures.

The active device array 130 is disposed at the first substrate 110, which is proximal to the display side. Hence, the active device A may be a transparent thin film transistor for increasing the probability of the external lights to irradiate the solar cell structure 140. Alternatively speaking, the gate G, the source S, the drain D, etc. may also be fabricated with transparent conductive materials. It should be appreciated by a person of ordinary skill practicing this invention that the transparent conductive materials being referred herein in the illustrated embodiments are presented by way of example and not by way of limitation. In other exemplary embodiments, these conductive devices may be fabricated with metal or other non-transparent conductive materials. Additionally, the active device A illustrated in FIG. 1 is a top gate thin film transistor. In other exemplary embodiments, the active device A may include a bottom gate thin film transistor, a low temperature polysilicon thin film transistor, an amorphous silicon thin film transistor, or an organic thin film transistor, etc.

Comparatively speaking, the fabrication procedure and the device design of the active device array 130 are more complicated than those of the common electrode layer 170. According to the design in the exemplary embodiment, the active device array 130 is disposed on the first substrate 110, and the common electrode 170 is disposed adjacent to one side of the solar cell structure 140. Hence, the solar cell structure 140 is prevented from being damaged during the fabrication of the active device array 130. Accordingly, the liquid crystal display panel 100 has a high yield.

In the exemplary embodiment of the disclosure, the cholesteric liquid crystal layer 160 includes multiple cholesteric liquid crystal materials I, II, III, and these cholesteric liquid crystal materials I, II, II may reflect different colored lights. Hence, the liquid crystal display panel 100 may provide the multi-color display function. Alternatively speaking, the cholesteric liquid crystal materials I, II, III may respectively be one of the cholesteric liquid crystal material reflecting a red-colored light, the cholesteric liquid crystal material reflecting a green-colored light, and the cholesteric liquid crystal material reflecting a blue-colored light. For example, the range of the reflective wavelength of colored lights reflected by the cholesteric liquid crystal materials is between about 400 nm to about 900 nm. The cholesteric liquid crystal layer 160 may also employ a cholesteric liquid crystal material to provide the liquid crystal display panel 100 with a single color display function or a display function of a black-and-white image.

Additionally, in the exemplary embodiment, the cholesteric liquid crystal materials I, II, III reflecting different colors are disposed side-by-side between the active device array 130 and the common electrode 170. Alternatively speaking, in the direction vertical to the first substrate 110, these cholesteric liquid crystal materials I, II, III do not overlapped with each other. However, in the liquid crystal display panel, as shown in FIG. 2, in the direction vertical to the first substrate 110, these cholesteric liquid crystal materials I, II, III are stacked together, wherein these cholesteric liquid crystal materials I, II, III are separated by a spacing material layer 162.

In accordance to the aforementioned disclosure, the liquid crystal display panel is integrated with a solar cell structure, and the solar cell structure and common electrode layer in the display device are directly fabricated at two corresponding sides of a single isolation layer. Hence, in the liquid crystal display panel in the disclosure, the solar cell and the display panel are bonded together without the application of an adhesive layer, which would simplify the assembled structure of the liquid crystal display panel. Moreover, the chances that the solar cell structure accepting external lights are greatly increased to provide higher photoelectric conversion efficiency. Accordingly, the power mandated by the liquid crystal display panel may be provided partially or completely by the solar cell to achieve better power efficiency. Furthermore, the solar cell structure could be dark color to enhance the display contrast of the cholesteric liquid crystal display panel. In other words, the cholesteric liquid crystal display panel may have desirable display quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display panel, comprising:
a first substrate;
a second substrate, facing opposite to the first substrate;
an active device array, disposed on the first substrate and located between the first substrate and the second substrate;
a solar cell structure, disposed on the second substrate and located between the active device array and the second substrate;
an isolation layer, configured between the solar cell structure and the active device array;
a cholesteric liquid crystal layer, disposed between the isolation layer and the active device array; and
a common electrode layer, disposed between the cholesteric liquid crystal layer and the isolation layer, and corresponding two sides of the isolation layer are in direct contact with the common electrode and the solar cell structure, respectively.

2. The liquid crystal display panel of claim 1, wherein the isolation layer is an integral or continuous single layer structure.

3. The liquid crystal display panel of claim 2, wherein the isolation layer is a third substrate, an insulative passivation layer or an insulative anti-reflection layer.

4. The liquid crystal display panel of claim 1, wherein the solar cell structure comprises:
a first conductive layer, disposed on the second substrate;
a second conductive layer, in direct contact with the isolation layer; and
a photovoltaic layer, disposed between the first conductive layer and the second conductive layer.

5. The liquid crystal display panel of claim 1, wherein the active device array comprises an active device and a pixel electrode, and the pixel electrode is electrically connected with the active device.

6. The liquid crystal display panel of claim 5, wherein the active device comprises a transparent thin film transistor.

7. The liquid crystal display panel of claim 1, wherein the cholesteric liquid crystal layer includes multiple cholesteric liquid crystal materials, and the multiple cholesteric liquid crystal materials reflect different colored lights.

8. The liquid crystal display panel of claim 7, wherein a range of a reflective wavelength of colored lights reflected by the cholesteric liquid crystal materials is between about 400 nm to about 900 nm.

9. The liquid crystal display panel of claim 7, wherein the cholesteric liquid crystal materials are arranged side-by-side.

10. The liquid crystal display panel of claim 7, wherein the cholesteric liquid crystal materials are stacked together.
